(19) United States
(12) Patent Application Publication
(10) Pub. No.: US 2026/0177396 A1
(43) Pub. Date: Jun. 25, 2026

(54) INFORMATION PROCESSING SYSTEM, CONTROL METHOD FOR INFORMATION PROCESSING SYSTEM, INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: MASASHI SHIDARE, Chiba (JP)

(21) Appl. No.: 19/419,954

(22) Filed: Dec. 15, 2025

(30) Foreign Application Priority Data
Dec. 23, 2024 (JP) 2024-226779

(51) Int. Cl. G01C 21/00

(52) U.S. Cl. CPC G01C 21/3811; G01C 21/3856

(57) ABSTRACT

An information processing system includes at least one processor operating to accept input of course conditions from a user, and generate a course based on the course conditions and information on courses previously used by a plurality of users. The course conditions include a travel distance.

### BACKGROUND

### Field of the Technology

The present disclosure relates to an information processing system, a control method for the information processing system, an information processing apparatus, a control method for the information processing apparatus, and a storage medium.

### Description of the Related Art

Wearable terminals equipped with a Global Positioning System (GPS) function, which can record distances, speeds, and the like for activities, such as running and cycling, have become widespread.

In addition, navigation devices are known that propose driving routes for vehicles by considering various conditions, such as the technique described in Japanese Patent Laid-Open No. 2019-203781.

### SUMMARY

According to an aspect of the present disclosure, an information processing system includes at least one processor operating to accept input of course conditions from a user, and generate a course based on the course conditions and information on courses previously used by a plurality of users. The course conditions include a travel distance.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an overview of an information processing system according to an embodiment.

FIGS. 2A to 2C are block diagrams illustrating functional configurations of an electronic device, an information processing apparatus, and a server device according to the present embodiment.

FIGS. 3A and 3B are sequence diagrams illustrating an overview of information processing methods according to the present embodiment.

FIG. 4 is a flowchart illustrating a process executed by the information processing apparatus according to the present embodiment.

FIGS. 5A and 5B are diagrams illustrating examples of screens displayed on a display unit of the information processing apparatus according to the present embodiment.

FIGS. 6A and 6B are diagrams illustrating examples of screens displayed on the display unit of the information processing apparatus according to the present embodiment.

FIG. 7 is a diagram illustrating an example of a screen displayed on the display unit of the information processing apparatus according to the present embodiment.

FIG. 8 is a table illustrating an example of information recorded in the server device according to the present embodiment.

### DESCRIPTION OF THE EMBODIMENTS

Hereinafter, embodiments of the present disclosure will be described in detail with reference to the attached drawings. The following embodiments do not limit the present disclosure as defined by the scope of the claims, and not all combinations of features described in the embodiments are necessarily essential to the solution of the present disclosure. Furthermore, a desired combination of a plurality of features may be used. In the attached drawings, the same or similar components are denoted by the same reference numerals, and redundant descriptions will be omitted.

First, an information processing system and the like according to an embodiment will be described.

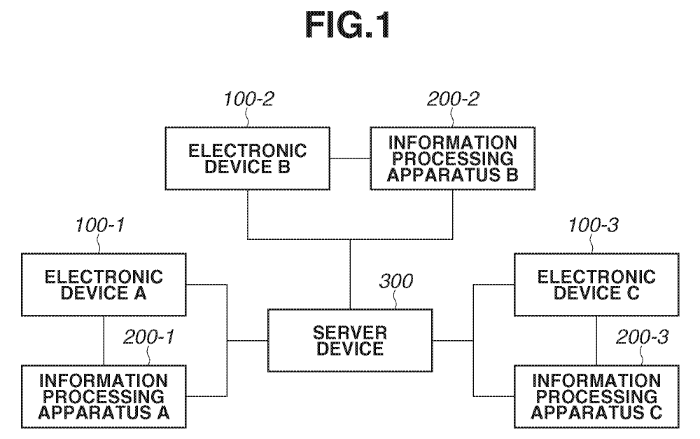

FIG. 1 is a block diagram illustrating an overview of a communication system according to the present embodiment. A server device 300 is used for providing a service managed by a manufacturer or the like that provides electronic devices A100-1, B100-2, and C100-3.

Here, it is assumed that a user A possesses the electronic device A100-1 and an information processing apparatus A200-1. Similarly, a user B possesses the electronic device B100-2 and an information processing apparatus B200-2, and a user C possesses the electronic device C100-3 and an information processing apparatus C200-3. In FIG. 1, only three electronic devices and three information processing apparatuses are illustrated, but the number may be more or less than three.

Hereinafter, unless it is necessary to distinguish, the electronic devices A100-1, B100-2, and C100-3 are collectively referred to as the electronic device 100. Similarly, the information processing apparatuses A200-1, B200-2, and C200-3 are collectively referred to as the information processing apparatus 200.

The electronic device 100, the information processing apparatus 200, and the server device 300 are each connected so as to be capable of communication. The electronic device 100 may be configured to communicate only with the information processing apparatus 200 and not directly with the server device 300. A desired communication method for communication between the electronic device 100, the information processing apparatus 200, and the server device 300 may be selected from known techniques. The electronic device 100 and the information processing apparatus 200 are typically in close proximity, so that it is desirable to use Bluetooth®, but other communication forms may also be employed.

Examples of the electronic device 100 include devices that are easy to wear during exercise, such as a wristwatch (so-called smart watch) and a chest belt. The electronic device 100 may be configured as a single wristwatch, or may be composed of a plurality of devices, such as a wristwatch and a chest belt.

Examples of the information processing apparatus 200 include a personal computer, a smartphone, and a tablet terminal. In the present embodiment, it is assumed that an application program provided by the manufacturer of the electronic device 100 is installed in the information processing apparatus 200, and information processing methods described below are implemented by executing the application program. However, a function pre-installed in an operating system (OS) of the information processing apparatus 200 or an application program provided by an OS provider (such as health management or map applications) may be employed.

The information processing apparatus 200 may be a single device, or a personal computer, and a smartphone may be used together depending on the user's preference.

In addition, only the information processing apparatus 200 provided with a function of the electronic device 100, which will be described below, may implement the information processing methods according to the present embodiment without using the electronic device 100. In such a case, for example, it is conceivable to provide an application installed in the information processing apparatus 200 with a function of executing the information processing methods according to the present embodiment.

The server device 300 transmits and receives various kinds of information to and from the electronic device A100-1, the information processing apparatus A200-1, the electronic device B100-2, the information processing apparatus B200-2, the electronic device C100-3, and the information processing apparatus C200-3. For example, the server device 300 collects location information from the electronic device 100 or transmits course information to the information processing apparatus 200.

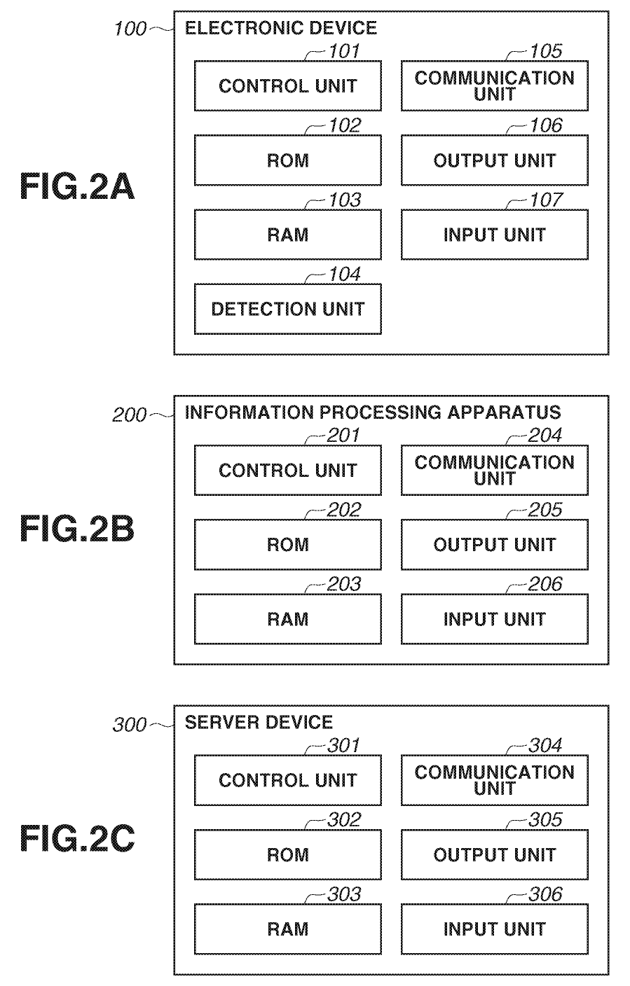

FIGS. 2A to 2C are block diagrams illustrating functional configurations of the electronic device 100, the information processing apparatus 200, and the server device 300 according to the present embodiment, respectively.

As illustrated in FIG. 2A, the electronic device 100 includes a control unit 101, a read only memory (ROM) 102, a random-access memory (RAM) 103, a detection unit 104, a communication unit 105, an output unit 106, and an input unit 107.

The control unit 101 is, for example, a processor, such as a central processing unit (CPU). The control unit 101 implements the information processing methods described below by executing programs stored in the ROM 102 and/or the RAM 103.

The detection unit 104 has at least a Global Positioning System (GPS) function. In addition to the GPS function, the detection unit 104 may be capable of detecting heart rate, acceleration, temperature, atmospheric pressure, and the like. Information detected by the detection unit 104 is transmitted to the information processing apparatus 200 and/or the server device 300 by the communication unit 105.

For example, a display (such as a liquid crystal display or organic electro-luminescence (EL) display) for displaying information to the user is mainly assumed to be used as the output unit 106, but the output form may take any suitable type, such as sound, vibration, indication by an analog meter, or light emission from a lamp. The input unit 107 is, for example, a button or a touch panel that receives operations from the user. The input unit 107 may also be a voice input that detects and analyzes the user's voice to accept the voice as an instruction.

As illustrated in FIG. 2B, the information processing apparatus 200 includes a control unit 201, a ROM 202, a RAM 203, a communication unit 204, an output unit 205, and an input unit 206.

The control unit 201 is, for example, a processor, such as a CPU. The control unit 201 implements the information processing methods described below by executing programs stored in the ROM 202 and/or the RAM 203.

The communication unit 204 transmits and receives information to and from the electronic device 100 and the server device 300. For example, a display (such as a liquid crystal display or organic EL display) for displaying information to the user is mainly assumed to be used as the output unit 205, but the output form may take any suitable type, such as sound, vibration, indication by an analog meter, or light emission from a lamp. The input unit 206 is, for example, a keyboard, mouse, or touch panel that receives operations from the user. The input unit 206 may also be a voice input that detects and analyzes the user's voice to accept the voice as an instruction.

As illustrated in FIG. 2C, the server device 300 includes a control unit 301, a ROM 302, a RAM 303, a communication unit 304, an output unit 305, and an input unit 306.

The control unit 301 is, for example, a processor, such as a CPU. The control unit 301 implements the information processing methods described below by executing programs stored in the ROM 302 and/or the RAM 303.

The communication unit 304 transmits and receives information to and from the electronic device 100 and the information processing apparatus 200.

For example, a display (such as a liquid crystal display or organic EL display) for displaying information to the user is mainly assumed to be used as the output unit 305, but the output form may take any suitable type, such as sound, vibration, indication by an analog meter, or light emission from a lamp. The input unit 306 is, for example, a keyboard, mouse, or touch panel that receives operations from the user. The input unit 306 may also be a voice input that detects and analyzes the user's voice to accept the voice as an instruction.

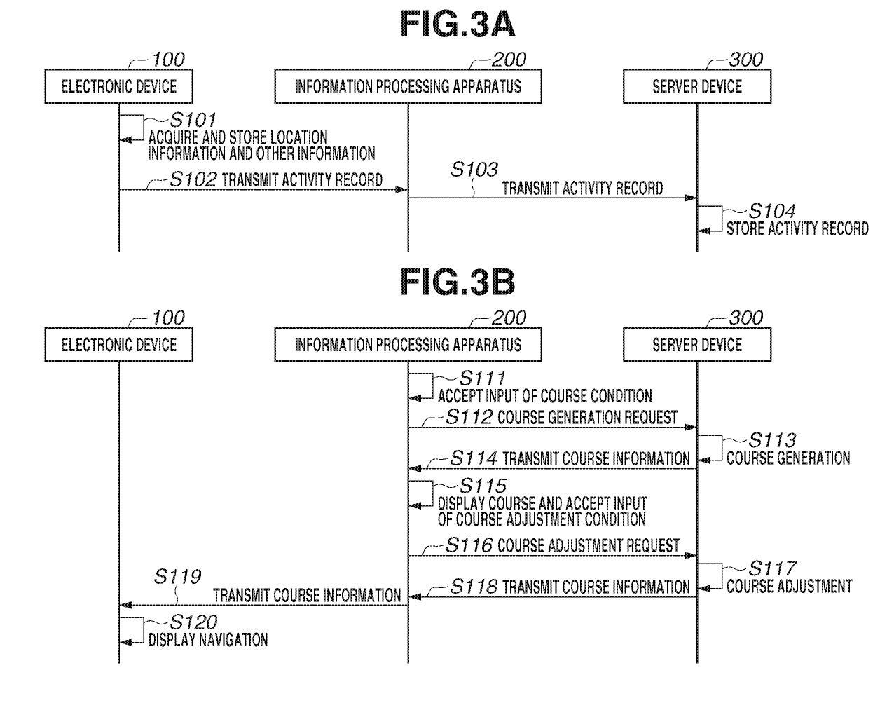

FIGS. 3A and 3B are sequence diagrams illustrating an overview of information processing methods according to the present embodiment. First, an information processing method during and after an activity will be described with reference to FIG. 3A.

The user of the electronic device 100 wears the electronic device 100 and performs an activity, such as running, cycling, walking, hiking, driving, or touring. In step S101, during an activity, the detection unit 104 of the electronic device 100 detects location information, and the control unit 101 stores the location information and the time at which the location information was detected in the RAM 103. At this time, heart rate may be measured, the number of steps and stride length may be measured from changes in acceleration, and temperature or atmospheric pressure (altitude) may also be measured.

In addition, the control unit 101 may calculate the travel speed using detection results from the detection unit 104. The calculated speed may be presented to the user by the output unit 106 or stored in the RAM 103. In this specification, detection results from the detection unit 104 and information calculated using the detection results are collectively referred to as an “activity record.” Not all of the above need to be included in the activity record.

In step S102, the communication unit 105 of the electronic device 100 transmits an activity record stored in the RAM 103 to the information processing apparatus 200. The information processing apparatus 200 stores the received activity record in the RAM 203.

In step S103, the communication unit 204 of the information processing apparatus 200 transmits the activity record stored in the RAM 203 to the server device 300. In step S104, the server device 300 stores the received activity record in the RAM 303.

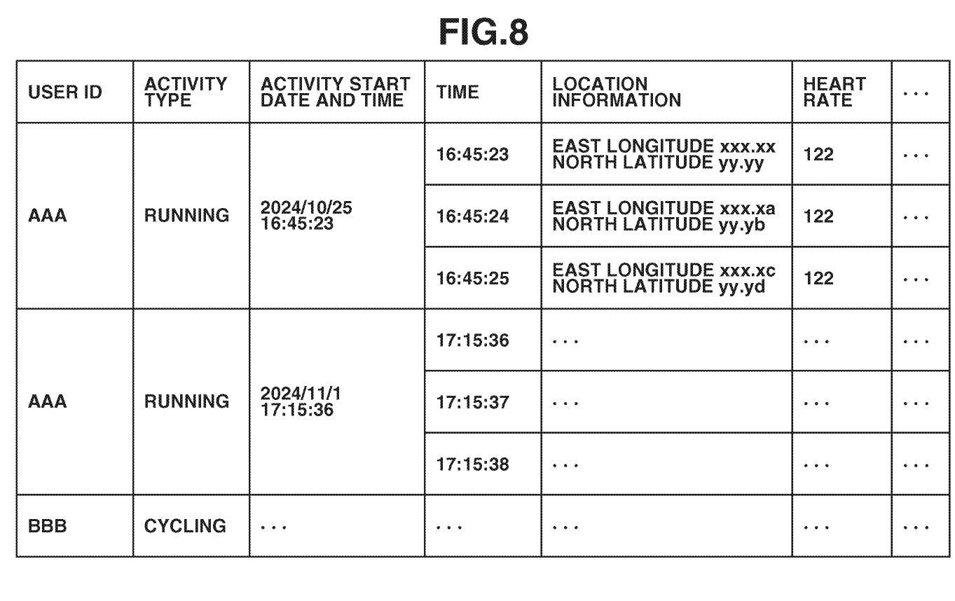

FIG. 8 is an example of the activity record that is transmitted to the server device 300 and stored in the RAM 303. As illustrated in FIG. 8, the information about the activity record may include activity information, such as a user identifier, an activity type, and a start date and time, and information, such as the time, location information, and a heart rate, for example, detected or recorded during the activity.

The location information is represented as information about latitude and longitude, but may include altitude. If the detection unit 104 is capable of measuring atmospheric pressure, relative changes in altitude from a reference point, such as the start point can be calculated. In addition, absolute altitude information for a point corresponding to the latitude and longitude may be added in the server device 300 provided with topographic map information.

In the present embodiment, as illustrated in steps S102 and S103, the activity record is described as being transmitted indirectly from the electronic device 100 to the server device 300 via the information processing apparatus 200. However, the activity record may also be transmitted directly from the electronic device 100 to the server device 300.

The operations in steps S102 to S104 may be performed after the activity has ended or at appropriate timings during the activity. For example, if the activity lasts for a long time, information may be output to the information processing apparatus 200 at appropriate timings, such as every hour, so that information that has already been output can be deleted from the RAM 103 of the electronic device 100.

Next, an information processing method for creating an activity course (also referred to as a route or path) will be described with reference to FIG. 3B. When performing an activity at a travel destination or the like, there may be cases where, due to unfamiliarity with the area, a user enters a road with frequent accidents or fails to notice a scenic route. If a course can be proposed that incorporates roads frequently used by many runners and/or cyclists, the effectiveness and satisfaction of the user's activity will thus be improved.

In step S111, the information processing apparatus 200 accepts input of desired course conditions from the user via the input unit 206. Details of the course conditions will be described below, but examples include a start point and distance.

In step S112, the communication unit 204 of the information processing apparatus 200 transmits a course generation request to the server device 300. The course generation request includes the course condition information accepted in step S111.

In step S113, the control unit 301 of the server device 300 generates a course based on one or more of the course conditions included in the course generation request, past activity records stored in the RAM 303, and other types of information. The past activity records may include activity records of users other than the user of the information processing apparatus 200 that has transmitted the course generation request.

The server device 300 stores activity records of a large number of users. It thus is desirable to generate a course that preferentially passes through routes which a high number of users have passed through for the same type of activity, such as running. The number of users that have passed through a route is conceivable as, for example, the total number of users in the most recent week (i.e., the number of activities with records indicating that a certain route was used in the most recent week). If a sufficient number of activities cannot be obtained, a longer period, such as the most recent month or year, may be used. If there are many activities, a shorter period, such as several days, may be used.

In addition, if there are many activities, the results may be narrowed down by conditions, such as speed. By narrowing down by speed, it is possible to generate a course preferred by users with a similar level.

Instead of a course which a high number of users have passed through, it is also conceivable that a course is generated that preferentially passes through locations (especially parks, convenience stores, etc.) which a high number of users have passed through. When using locations which a high number of users have passed through, it is conceivable that the course generation method generates a course similar to a course with a waypoint or waypoints set therein, reducing the processing load on the server device 300.

However, there is a concern that unnatural left and/or right turns and/or U-turns may be included in the course in order to pass through such locations, which may impair the comfort and satisfaction of the activity. On the other hand, if the course is generated so as to preferentially pass through routes which a high number of users have passed through, lines rather than points will be considered, making it easier to generate a natural course (with fewer repeated left and right turns and U-turns).

Instead of, or in addition to, the number of users who have used a route, it is also possible to generate a course that avoids locations where an accident occurred in the most recent year, or roads with no sidewalks and heavy road traffic.

In step S114, the communication unit 304 of the server device 300 transmits the course information generated in step S113 to the information processing apparatus 200.

In step S115, the control unit 201 of the information processing apparatus 200 displays the received course on the output unit 205. In addition, as with the course conditions in step S111, input of course adjustment conditions is accepted. The course adjustment conditions are course conditions accepted for the purpose of regenerating the course under different conditions when the user is not satisfied with a course the user generated.

In step S116, the communication unit 204 of the information processing apparatus 200 transmits a course adjustment request to the server device 300. The course adjustment request includes the course adjustment condition information accepted in step S115.

In step S117, the control unit 301 of the server device 300 generates a course based on one or more of the course adjustment conditions included in the course adjustment request, past activity records stored in the RAM 303, and other types of information. The past activity records may include activity records of users other than the user of the information processing apparatus 200 that transmitted the course generation request.

In step S118, the communication unit 304 of the server device 300 transmits the information about the adjusted and regenerated course in step S117 to the information processing apparatus 200. The control unit 201 of the information processing apparatus 200 displays the received course on the output unit 205. The operations of steps S115 to S118 may be repeated according to the user's desire.

In step S119, in response to an instruction from the user via the input unit 206, the communication unit 204 transmits the course information to the electronic device 100.

In step S120, the output unit 106 of the electronic device 100 displays navigation (such as a map or travel direction) based on the course information received in step S119. The operation of step S120 is executed when the user starts the activity. The activity may be started in response to, for example, an operation by the user, such as pressing a start button as the input unit 107 of the electronic device 100, or detection of movement at a predetermined speed or more by the detection unit 104.

In the present embodiment, course generation is performed by the server device 300, but the information processing apparatus 200 may obtain information necessary for course generation from the server device 300 as needed and generate the course.

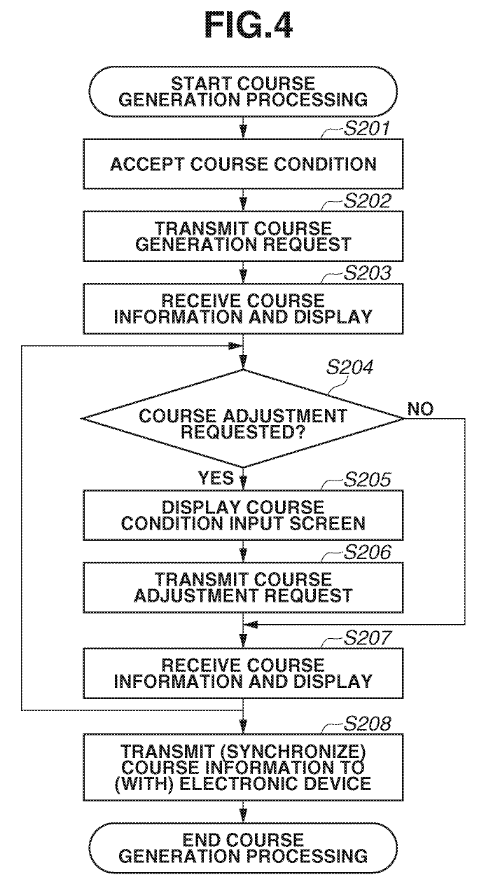

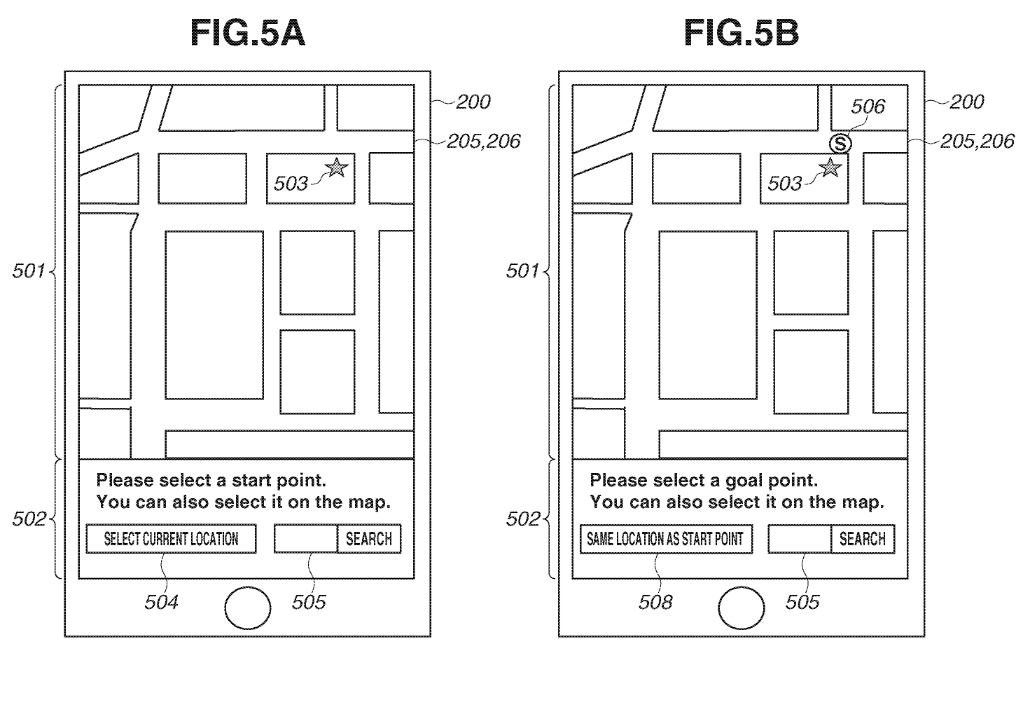

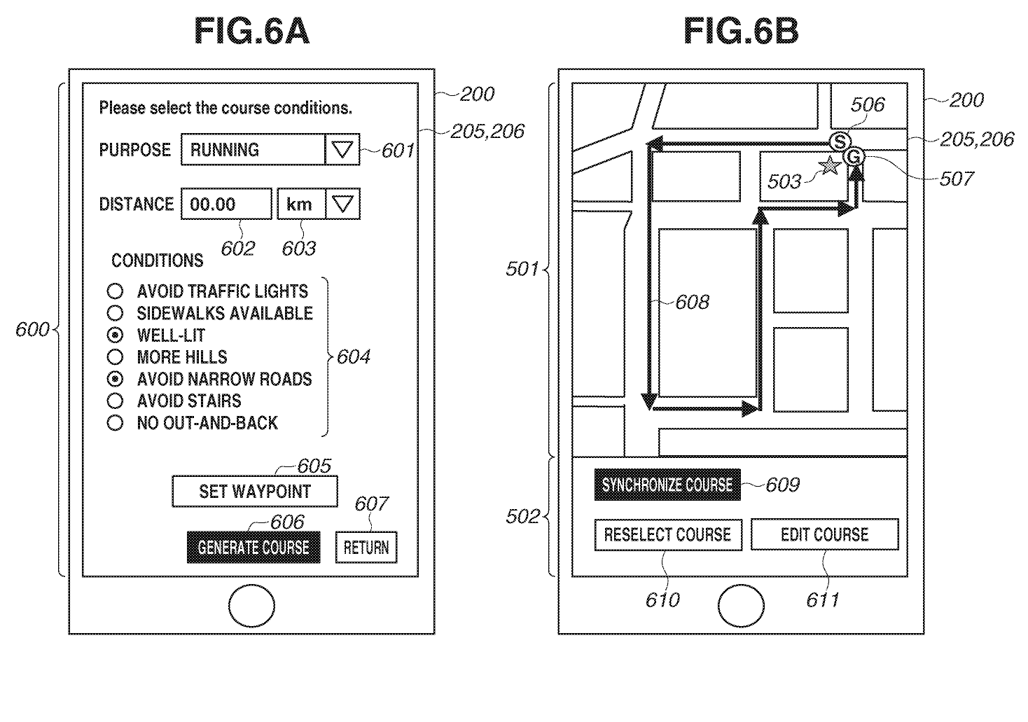

The process of FIG. 3B will be described in more detail with reference to FIG. 4, FIGS. 5A and 5B, and FIGS. 6A and 6B. FIG. 4 is a flowchart illustrating a process executed by the information processing apparatus 200 according to the present embodiment. FIGS. 5A and 5B are diagrams illustrating examples of screens displayed on a display unit of the information processing apparatus 200 according to the present embodiment. FIGS. 6A and 6B are diagrams illustrating examples of screens displayed on the display unit of the information processing apparatus 200 according to the present embodiment.

The flow of FIG. 4 is started in response to the user of the information processing apparatus 200 attempting to use the course generation function via the input unit 206. For example, it is conceivable that the user launches an application used for the electronic device 100 and selects the course generation function in the application.

The application used for the electronic device 100 is an application provided by the manufacturer of the electronic device 100, and can be downloaded and installed from an application store or the like provided by the provider of the OS of the information processing apparatus 200. The application used for the electronic device 100 may also allow the user to view past activity records.

Instead of the application used for the electronic device 100, an application or a function of the OS provided by the provider of the OS of the information processing apparatus 200 may be also used. For example, it is conceivable that a health management application or a map application is used.

In step S201, the control unit 201 displays a screen for accepting course generation conditions on the output unit 205 and accepts input of course conditions from the user via the input unit 206. Then, in step S202, the control unit 201 causes the communication unit 204 to transmit a course generation request including the course condition information to the server device 300. In step S203, the communication unit 204 receives course information from the server device 300, and the control unit 201 displays the generated course on the output unit 205. Specific examples of the operations in steps S201 to S203 are illustrated in FIGS. 5A and 5B, and FIGS. 6A and 6B.

First, the control unit 201 displays a start point setting screen as illustrated in FIG. 5A on the output unit 205. The screen of FIG. 5A displays a map display area 501 and an information display and input area 502. The start point is an example of a movement start point.

The map display area 501 displays a current location icon 503. The information display and input area 502 displays guidance for an operation to be performed by the user, such as “Please select a start point. You can also select it on the map.” In addition, the information display and input area 502 may include an object 504 for setting the current location as the start point and a search object 505 for searching for parks, sports facilities, and the like using their names.

The start point can be set by selecting (tapping, clicking, etc.) any point on the map. To prevent erroneous setting of a point different from the user's intention, the start point may be set by detecting such user operations as a double tap, double click, and a touch and hold for a predetermined time. In addition, by selecting the object 504, the position indicated by the current location icon 503 can be set as the start point. Parks, sports facilities, or the like found by searching using the search object 505 may be settable as the start point.

When the start point is set, the control unit 201 displays a goal point setting screen as illustrated in FIG. 5B on the output unit 205. The screen of FIG. 5B also displays the map display area 501 and the information display and input area 502, as in the screen of FIG. 5A. The goal point is an example of a movement end point.

The map display area 501 displays a start point icon 506 indicating the start point selected by the user via the screen of FIG. 5A. The information display and input area 502 displays guidance for an operation to be performed by the user, such as “Please select a goal point. You can also select it on the map.” In addition, the information display and input area 502 may include an object 507 for setting the same location as the start point as the goal point and the search object 505 for searching for parks, sports facilities, and the like.

The method for selecting the goal point is the same as the method for selecting the start point described above.

When the goal point is set, the control unit 201 displays a course conditions input screen as illustrated in FIG. 6A on the output unit 205. The course conditions input screen includes a course conditions input area 600 which displays guidance for an operation to be performed by the user, such as “Please select the course conditions.”

The course conditions input area 600 may display a purpose selection control item 601, a distance input field 602, a control item 603 for selecting the unit of distance, and a condition selection object group 604. In addition, the course conditions input area 600 may display an object 605 for setting waypoints, an object 606 for outputting a course generation instruction, an object 607 for returning to the previous screen, and the like.

The purpose selection control item 601 displays a pull-down menu which displays options when tapped or clicked. Examples of options include running, jogging, walking, cycling, and trail running. Considering the occupied area on the screen, a pull-down menu is desirable, but as with the object group 604, all options may be displayed.

The distance input field 602 is a field where the user directly inputs a distance for the activity. For example, in response to a tap on the distance input field 602, a software keyboard is displayed to accept input. After clicking the distance input field 602, input may be also accepted via a hardware keyboard connected to the information processing apparatus 200.

The control item 603 for selecting the unit of distance displays a pull-down menu which displays options when tapped or clicked. Examples of options include kilometers and miles.

The condition selection object group 604 lists conditions for generating the course, and when an option is selected, a small black circle is displayed inside the white circle on the left side of the option. Instead of round objects, checkboxes and the like may be used. The condition selection object group 604 may be configured to display a pull-down menu with one or several options, as with the control item 601, but as in the present embodiment, the object group configured as the condition selection object group 604 makes it possible to accept any number of conditions.

The options shown in the condition selection object group 604 in FIG. 6A are merely examples, and other options may be included, or not all of the options shown in FIG. 6 may be included. In the present embodiment, all of the condition selection object group 604 may be selected at the user's discretion, but an upper limit to the number of selectable options may be set in consideration of the processing load on the server device 300. If an upper limit is set, it is desirable to clearly indicate the number of selectable options on the screen.

When the object 605 for setting waypoints is selected, the control unit 201 displays a screen similar to the ones as in FIGS. 5A and 5B on the output unit 205, and on the screen, the setting of waypoints by selection on the map or by searching for facility names and the like is accepted.

In step S202, in response to selection of the object 606 for outputting a course generation instruction, the control unit 201 causes the communication unit 204 to transmit a course generation request to the server device 300.

In step S203, after the communication unit 204 receives course information from the server device 300, the control unit 201 displays a course confirmation screen as illustrated in FIG. 6B on the output unit 205.

The course confirmation screen shown in FIG. 6B also displays the map display area 501 and the information display and input area 502, as in the screens of FIGS. 5A and 5B.

The map display area 501 displays the start point icon 506 indicating the start point selected by the user via the screen of FIG. 5A, and a goal point icon 508 indicating the goal point selected by the user via the screen of FIG. 5B. In addition, the course indicated by the course information is displayed on the map in the map display area 501 using arrow objects 608. Instead of the arrow objects 608, the course with a line in any color or by filling the road with any color may be represented.

The information display and input area 502 may include an object 609 for transmitting (synchronizing) the course information to (with) the electronic device 100, an object 610 for reselecting course conditions, and an object 611 for editing the course.

Returning to the description of the flowchart in FIG. 4, in step S204, the control unit 201 determines whether a course adjustment requested by the user has been accepted. In the course confirmation screen shown in FIG. 6B, if the object 610 is selected, it is determined that the course adjustment has been requested; if the object 609 is selected, it is determined that a course adjustment has not been requested.

In step S204, if the user selects the object 609 (NO in step S204), the process proceeds to step S208. In step S208, the control unit 201 causes the communication unit 204 to transmit (synchronize) the course information to (with) the electronic device 100.

On the other hand, if the user selects the object 610 (YES in step S204), the process proceeds to step S205. In step S205, the control unit 201 displays the course conditions input screen as illustrated in FIG. 6A on the output unit 205. It is desirable for the conditions accepted in step S201 to be kept selected, which reduces the effort required for the user to set the conditions again and allows the user to confirm the conditions already selected.

The screen displayed in step S205 may be any screen illustrated in FIGS. 5A or 5B, but there are not many cases where the start and/or goal point are or is to be changed, so that the course conditions input screen as illustrated in FIG. 6A is displayed here.

From step S205 through step S207, the control unit 201 accepts user input for amendment of the course and executes the amendment by repeating processing similar to that of steps S201 through S203.

In the course confirmation screen shown in FIG. 6B, the operations of steps S204 to S207 are repeated until the user selects the object 609.

On the other hand, there may be cases where, even if the course conditions are changed, the course is not generated that matches the one the user is imagining. The object 611 for editing the course is thus provided, and by selecting the object 611, the user may become able to edit the course directly.

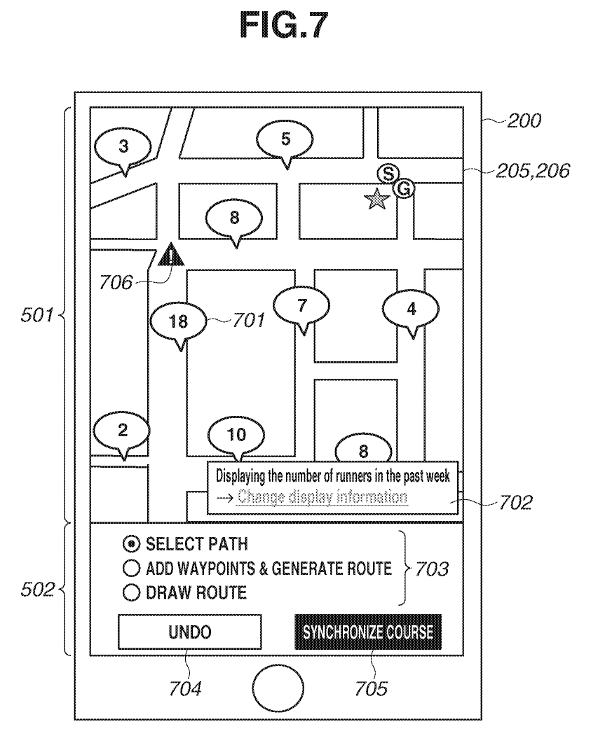

FIG. 7 is a diagram illustrating an example of a screen displayed on the display unit in the information processing apparatus 200 according to the present embodiment. A course editing screen illustrated in FIG. 7 also displays the map display area 501 and the information display and input area 502, as in the screens of FIGS. 5A and 5B.

In the example of FIG. 7, as described in a guidance message 702, the map display area 501 displays user count icons 701 indicating the number of users who passed through each course in the most recent week. In addition, a warning icon 706 indicating a point where an accident or accidents occurred in the past may also be displayed.

The guidance message 702 may also display a character string with a link or an object for changing the display information. As display information, in addition to the number of users, information, such as traffic volume, number of streetlights, hills, sidewalks, intersections with traffic signals, and stairs, may be able to be displayed. While the number of users is displayed in FIG. 7, traffic volume or streetlights may be displayed in different colors of the road like a heat map; hills may be displayed using arrows indicating the downhill direction; and sidewalks, signals, stairs, and other types of features may be displayed using icons indicating these features. A plurality of pieces of information may be displayed together, or only one piece of information may be displayed at a time.

In addition, the information display and input area 502 of the course editing screen illustrated in FIG. 7 include an object group 703 for selecting an editing method, an object 704 for undoing the editing operation, and an object 705 for transmitting course information to the electronic device 100.

The object group 703 for selecting an editing method includes, as illustrated in FIG. 7, three options: selecting a path, automatic generation by selecting waypoints, and drawing a route. However, some of these options alone may be displayed, or another option or other options may be provided.

When SELECT PATH is selected, for example, the control unit 201 accepts the selection of a path (by tapping, clicking, etc.) via the input unit 206, and sets the section between intersections on both end sides of the selected path as a course. The user repeats the selection of a path to determine the course. At this time, the control unit 201 may display the total distance of the selected paths on the output unit 205.

When ADD WAYPOINTS & GENERATE ROUTE is selected, for example, as with the selection of the object 605 described above, the control unit 201 displays a screen as in FIGS. 5A or 5B on the output unit 205 and accepts the setting of waypoints.

When DRAW ROUTE is selected, for example, the control unit 201 accepts the drawing of a course by the user via the input unit 206. As a method for drawing a course, for example, the user may trace a path or paths on the map with a finger or mouse cursor.

Displayed information, such as the user count icon 701 or the warning icon 706, makes it possible to support the user's consideration of a course, especially when selecting a path or drawing a route. In addition, in the map display area 501 of the course editing screen shown in FIG. 7, a course generated by the server device 300 may be displayed as a highly transparent (or light-colored) line or dotted line. A displayed course generated by the server device 300 improves operability when the user wants to modify only a part of the course.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-226779, filed December 23, 2024, which is hereby incorporated by reference herein in its entirety.

What is claimed is:

1. An information processing system comprising at least one processor operating to:
accept input of course conditions from a user; and generate a course based on the course conditions and information on courses previously used by a plurality of users,
wherein the course conditions include a travel distance.

2. A control method for an information processing system, the control method comprising:
accepting input of course conditions from a user; and
generating a course based on the course conditions and information on courses previously used by a plurality of users,
wherein the course conditions include a travel distance.

3. The control method for the information processing system according to claim 2, wherein the information processing system includes an information processing apparatus and a server device, the method further comprising:
causing the information processing apparatus to accept input of the course conditions;
causing the information processing apparatus to transmit the accepted course conditions to the server device;
causing the server device to generate a course based on the course conditions and the information on courses previously used by a plurality of users; and
causing the server device to transmit information on the generated course to the information processing apparatus.

4. The control method for the information processing system according to claim 3, wherein the information processing system further includes an electronic device, the method further comprising causing the information processing apparatus to transmit the course information received from the server device to the electronic device.

5. The control method for the information processing system according to claim 4, wherein the electronic device is a wristwatch.

6. An information processing apparatus communicable with a server device that stores information on courses of movement previously used by a plurality of users, the information processing apparatus being configured to:
accept input of course conditions from a user, the course conditions including a travel distance;
transmit the accepted course conditions to the server device;
generate a course based on the course conditions and the information on courses of movement previously used by a plurality of users; and
display the generated course.

7. A control method for an information processing apparatus communicable with a server device that stores information on courses of movement previously used by a plurality of users, the control method comprising:
accepting input of course conditions from a user, the course conditions including a travel distance;
transmitting the accepted conditions to the server device;
generating a course based on the course conditions and the information on courses of movement previously used by a plurality of users; and
displaying the generated course.

8. The control method for the information processing apparatus according to claim 7, the control method further comprising:
after displaying the generated course, accepting input of a second condition different from the course conditions from the user;
transmitting the accepted second condition to the server device; and generating a course based on the second condition and the information on courses previously used by a plurality of users; and
displaying the generated course.

9. The control method for the information processing apparatus according to claim 7, the control method further comprising accepting selection of a path to be included in the course from the user.

10. The control method for the information processing apparatus according to claim 7, the control method further comprising accepting drawing of a course from the user.

11. The control method for the information processing apparatus according to claim 7, the control method further comprising, when accepting the drawing, displaying the number of times the course was included in the courses of movement previously used by a plurality of users during a predetermined period.

12. A non-transitory computer readable storage medium storing an application program that causes an information processing apparatus communicable with a server device that stores information on courses of movement previously used by a plurality of users to:
accept input of course conditions from a user, the course conditions including a travel distance;
transmit the accepted course conditions to the server device;
generate a course based on the course conditions and the information on courses of movement previously used by a plurality of users; and
display the generated course.

13. The non-transitory computer readable storage medium according to claim 12, wherein after causing the information processing apparatus to display the generated course, the application further causes the information processing apparatus to:
accept input of a second condition different from the course conditions from the user; transmit the accepted second condition to the server device;
generate a course based on the second condition and the information on courses of movement previously used by a plurality of users; and
display the generated course.

14. The non-transitory computer readable storage medium according to claim 12, wherein the application further causes the information processing apparatus to accept selection of a path to be included in the course from the user.

15. The non-transitory computer readable storage medium according to claim 12, wherein the application further causes the information processing apparatus to accept drawing of a course from the user.

16. The non-transitory computer readable storage medium according to claim 15, wherein when causing the information processing apparatus to accept the drawing, the application further causes the information processing apparatus to display the number of times the course was included in the courses of movement previously used by a plurality of users during a predetermined period.
